(19) United States
(12) Patent Application Publication
(10) Pub. No.: US 2012/0140239 A1
(43) Pub. Date: Jun. 7, 2012

(54) METHOD FOR MONITORING THIN FILM DEPOSITION USING DYNAMIC INTERFEROMETER

(76) Inventors: Cheng-Chung LEE, (US); Kai Wu, (US)

(21) Appl. No.: 13/152,979

(22) Filed: Jun. 3, 2011

(30) Foreign Application Priority Data
Dec. 6, 2010 (TW) 099142374

(51) Int. Cl. G01B 9/02

(52) U.S. Cl. 356/491

(57) ABSTRACT

A method for real-time monitoring thin film deposition using a dynamic interferometer is revealed. An optical monitoring extracting the temporal phase change of the reflection coefficient of the deposition film stacks. The dynamic interferometer, which gets rid of the influence of vibration and air turbulence, was used in the method to directly detect fluctuating phase of a deposition film stack. Combing with the reflectance or transmittance measurements, the real-time reflection coefficient under normal incidence of monitoring light can be found as well as optical admittance for enhancing the error compensation of the thin film deposition.

### BACKGROUND OF THE INVENTION

1. Field of Invention

The present invention relates to a method for optical monitoring deposition and, in particular, to a method for monitoring thin film deposition using dynamic Interferometer.

2. Related Art

The optical monitoring method is generally thought better than other methods to manufacture optical filters, and for a costly optical filter manufacture, more precise optical monitor is necessary.

In a deposition thin film stack, the refractive indices of materials usually change so that suitable thickness of each layer would not be the same as what we expected in the original design; hence the termination point of each thin film layer needs to be revised. However, the conventional monitoring methods never analytically solve this problem. In the most conventional monitor system for coating deposition, only the transmittance and reflectance are measured. The deposition of quarter-wave film stack is usually terminated when the transmittance or reflectance locus reaches a local extreme value. However, the signal near the extreme value changes little with respect to increased thickness, and th extreme value e monitoring sensitivity is low. Among most methods, the turning points of extreme value are used to estimate the termination point of deposition in each layer. Some other monitoring methods, such as ellipsometry and broadband spectrum monitoring, use some computing algorithm to obtain optical constant by fitting the measurements, since the measurement includes too many parameters and they are hard to be solved analytically. There is no clearer rule to terminate the deposition through these monitors.

In this invention, a novel optical monitoring system is proposed to obtain the reflection coefficient, equivalent optical admittance, refractive index, and thickness of deposition film stacks analytically instead of applying numerical fitting. It provides higher precision in monitoring and more accurate error compensations. It helps the operator control the depositions more clearly, reduce the misjudgments of termination point of deposition, and improve the yield efficiency.

### SUMMARY OF THE INVENTION

The purpose of this invention is to provide a novel method for monitoring thin film deposition. By using a new-type polarization interferometer, the phase and magnitude of the reflection coefficients of monitoring light normally reflected from the deposition films can be acquired in real time, and the physical property changes of thin films can also be analytically found.

This invention employs the dynamic interferometry to process monitor for thin film growth. It can provide reflection coefficient loci or equivalent optical admittance loci to do monitor and the corresponding error compensations. The change in thickness and refractive index can also be known for non-absorption films. For the termination points near the left cross point of the real axis, a phase shift of pi can be added on the measured phase, and recalculate the optical admittance in order to increase the sensitivity in monitoring.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing the monitoring device according to one preferred embodiment of the invention;

FIG. 2 is a diagram showing the polarizer distribution on pixelated phase mask camera according to one preferred embodiment of the invention;

FIG. 3 is a diagram showing the normal incident light reflections inside the substrate according to one preferred embodiment of the invention; and

FIG. 4 is a flow chart according to one preferred embodiment of the invention.

Attachment 1 is a diagram showing a phase shift of pi on the reflection phase and re-calculate the corresponding optical admittance.

### DETAILED DESCRIPTION OF THE INVENTION

The present invention will be apparent from the following detailed description, which proceeds with reference to the accompanying drawings, wherein the same references relate to the same elements.

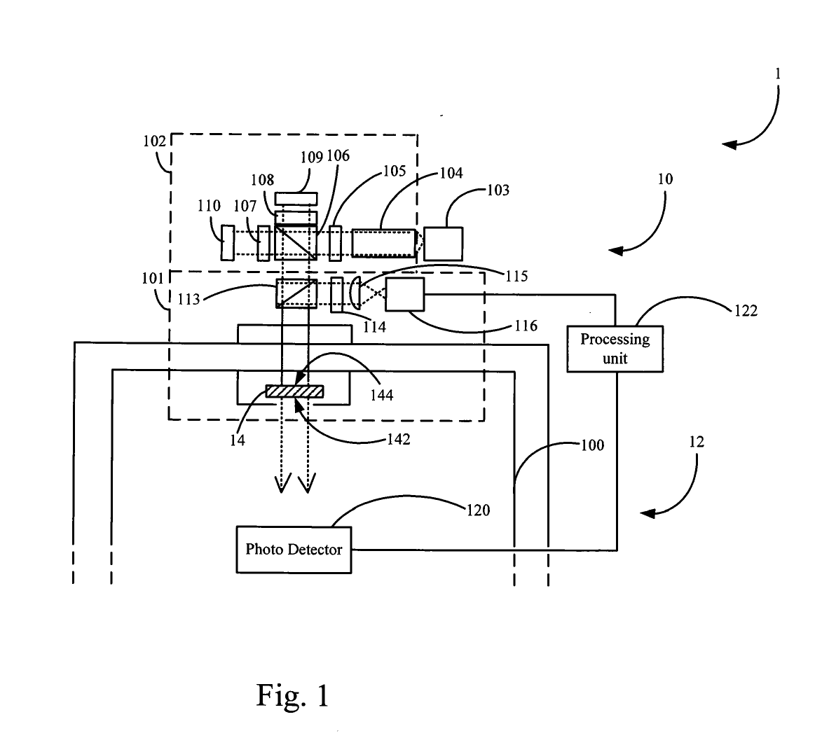

Referring to FIG. 1, a thin-film monitor device 1 is set outside of a coater 12, and is connected with a coater chamber 100. The thin-film monitoring device 1 includes a light source 103, a collimator 104, a dynamic interferometer 10, an imaging lens 115, a pixelated phase mask camera 116, a photo detector 120 and a processing unit 122, wherein the photo detector 120 disposed in the coater chamber 100, and a substrate 14 is also disposed in the coater chamber 100. The dynamic interferometer 10 is combined by a Fizeau polarization interferometer 101 and a Twyman-Green interferometer 102 preferably, but the present invention is not limited to the embodiment. The Fizeau polarization interferometer 101 includes a beam splitter 113, a quarter-wave plate 114. The Twyman-Green interferometer 102 includes a polarizer 105, a polarization beam splitter (PBS) 106, two quarter-wave plates 107, 108, two mirrors 109, 110.

The monitor system is set up outside the coater chamber 100. A Fizeau polarization interferometer 101 combining with a pixelated phase mask camera 116 is used to extract the optical phase, as shown in FIG. 1. After the light is emitted from the light source 103, it is then collimated by a collimator 104. The collimated light will pass through a polarizer 105, which is used to adjust the intensity ratio between the two orthogonally polarized lights. The polarization beam splitter (PBS) 106 will separate the two orthogonally polarized lights to different arms in the Twyman-Green interferometer 102. The two quarter-wave plates 107, 108 placed around the polarization beam splitter 106 were oriented to convert S to P polarized beam reflected from one mirror 109 and P to S polarized reflected from the other mirror 110, respectively. The lights come from two arms will be combined together again and go to the Fizeau cavity, that is our substrate. In our case, test surface 111 locates at the side where the thin film grows, and the other side of substrate is the reference surface 112. The reflected light will be directed to a quarter-wave plate by the beam splitter 113.

The quarter-wave plate 114 in front of the camera is oriented to convert two polarized beams coming from two arms of interferometer into two orthogonally circular polarization states. This quarter-wave plate 114 will make the reflection coefficient phase of thin films be derived from arctangent function of measured intensities rather than arccosine form. It provides higher sensitivity than the case without quarter-wave plate.

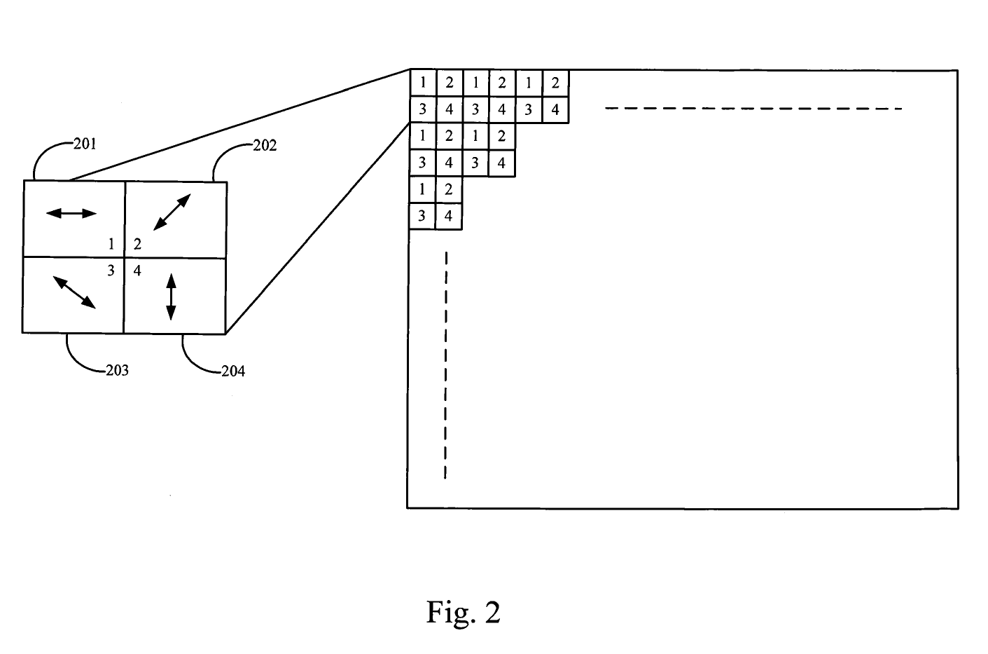

The lights go to the camera after passed through the imaging lens 115. The camera 116 has CCD array where each pixel has a polarizer on it, as shown in FIG. 2. Let the test beam be left circularly polarized with a phase of φ_{L} and the reference beam be right circularly polarized with a phase of φ_{R}. Further, let both beams be incident upon a linear polarizer oriented at an angle α with respect to the polarization direction of the reference beam. After passing through the polarizer, both the test and reference beams are linearly polarized at an angle α and a phase offset of +α has been added to the test beam, whereas a phase offset of −α has been added to the reference beam. The two beams are now collinear and will interfere to give an intensity pattern in accordance with:

I=I_{L}+I_{R}−2\sqrt{I_{L}I_{R}}cos(Φ+2α) (1)

where Φ(x, y)=φ_{L}−I_{L} and I_{R} are the intensities of left and right circle polarized beams.

The linear polarizer acts as a phase shifting device between the two beams, were the phase shift, 2α, is equal to twice the orientation angle of the polarizer.

The adjacent pixels on the camera have different orientation polarizer on them as shown in FIG. 2. There might be four different polarizers in a unit, 201, 202, 203, 204, and the unit is distributed periodically in the CCD array. There were four different polarizers at 0°, 45°, −45°, 90°, respectively, on the camera, and they generate four different phase shifted interferograms at once for phase shifting algorithm. The phases can be thereby calculated by phase shifting algorithm simultaneously.

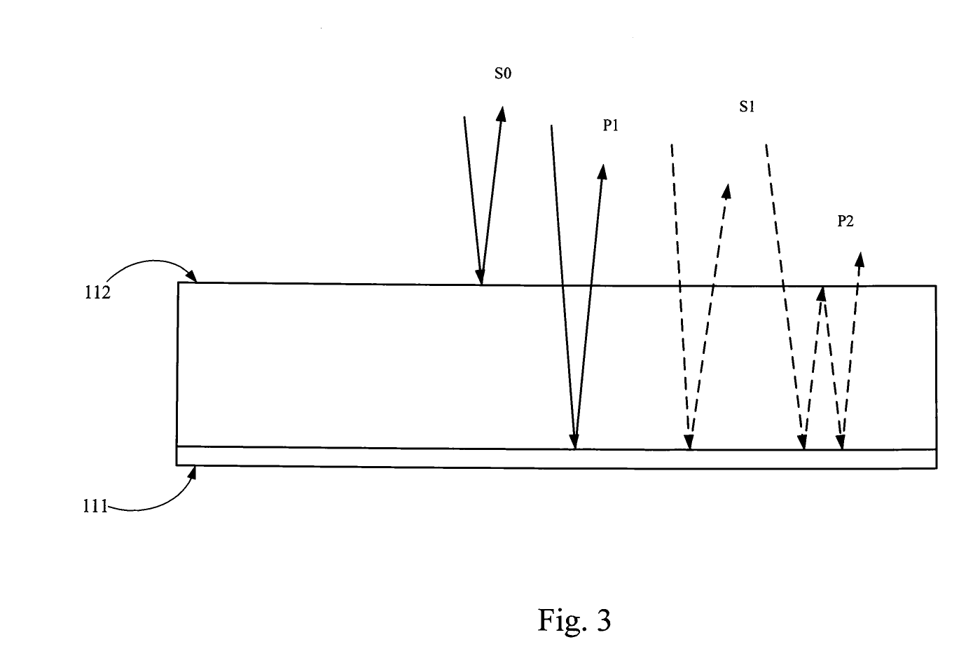

The rays are drawn spatially separate and with a slight slant in the sketch, FIG. 3, but are all normal to the surface and collinear in the monitoring system. The numbers within the cavity indicate the number of test surface reflections of each beam has passed before it exited the cavity.

Only the paired beams that are path matched and drawn in the same type of lines will interfere with each other, since the light has short coherence length. If we carefully adjust the translation stage of one arm of the Twyman-Green interferometer and let the distance to PBS 105 of the two mirrors 109, 110 have a difference of the optical thickness of substrate. Each successive reflection of the s-polarized beam off of the test surface is coherent with the p-polarized beam that has undergone one additional test surface reflection. Only the beam pair in which they undergo almost the same path lengths will have observable interference fringes; others will be suppressed due to low coherence.

The path matched S0 and P1, and S1 and P2, etc. are drawn with the same type of lines (e.g. dashed line for S0 and P1, dotted line for S1 and P2). The measured intensity can be presented as:

$$I = {I}_{P 0} + {I}_{S 0} + 2 \sqrt{{I}_{S 0} {I}_{P 1}} cos ϕ + {I}_{P 2} + {I}_{S 1} + 2 \sqrt{{I}_{S 1} {I}_{P 2}} cos ϕ + … + {I}_{P n} + {I}_{Sn - 1} + 2 \sqrt{{I}_{Pn} {I}_{Sn - 1}} cos ϕ \\ If n \to ∞ \\ I = ( {I}_{S} + {I}_{P} ) ( {R}_{r} + \frac{{( 1 - {R}_{r} )}^{2} {R}_{t}}{1 - {R}_{r} {R}_{t}} ) + 2 ( 1 - {R}_{r} ) \sqrt{{I}_{S} {I}_{P}} \sqrt{{R}_{r} {R}_{t}} ( \frac{( 1 - {R}_{r} )}{1 - {R}_{r} {R}_{t}} ) cos ϕ \qquad ( 2 )$$

where Rᵣ and Rₜ are the reflectance from the reference and test surfaces, respectively. φ is the phase difference between the two beams in each interfering beam pair.

The reflection phase of growing films coming from the test surface can be acquired by 4-step phase-shifting algorism in a single camera frame to freeze vibration effect:

$$Φ = arctan [ \frac{{I}_{- 45 °} - {I}_{45 °}}{{I}_{0 °} - {I}_{90 °}} ] \qquad ( 3 )$$

where Φ is the desired phase.

The obtained data in several frames should be averaged to erase the air turbulence influence.

Although the optical phase can be calculated in real-time and the distance between reference and test surface, that is the substrate thickness, should remain the same during coating process, the mechanical vibration of two mirrors in Twyman-Green can cause different tilts and shifts from time to time that will change the path difference between reference and test beams and influence the accuracy of calculated phase results. One part on the substrate test surface should be blocked and remain uncoated as a reference area. Since the beam coming from the reference area and tested film area pass through common path, the vibration effect can be cancel by subtracting the phase difference between the reference area and the monitored area before the deposition from that after the deposition; then the pure reflection phase of films can be acquired.

There is a photo-detector placed under the coater to receive the transmitted light intensity change. The magnitude of the reflection coefficient, square root of the reflectance, can be further acquired. The reflectance can be measured by the camera and Eq. (2).

After reflectance magnitude and phase are acquired, the reflection coefficient at normal incidence of light is known and optical admittance can be calculated by following relation:

$$γ {e}^{i θ} = \frac{{n}_{0} - ( α + i β )}{{n}_{0} + ( α + i β )} \qquad ( 4 )$$

where γ and θ are the magnitude and phase of the reflection coefficient, and n₀ is the refractive index of the incident medium.

In our case, the incident medium is substrate. Therefore, n₀ is equal to the refractive index of the substrate nₛ. α and β are given by follows.

$$α = \frac{{n}_{s} ( 1 - {γ}^{2} )}{1 + {γ}^{2} + 2 γ cos θ} , β = \frac{- 2 {n}_{s} γ sin θ}{1 + {γ}^{2} + 2 γ cos θ} \qquad ( 5 )$$

For non-absorption films, refractive index and thickness variation at every moment can also be calculated.

The optical admittance can be written down as:

$$α + i β = \frac{i n sin δ + ( {α}_{E} + i {β}_{E} ) cos δ}{cos δ + \frac{( i {α}_{E} - {β}_{E} )}{n} sin δ} \qquad ( 6 )$$

where α_{E} and β_{E} are the real and imaginary part of the equivalent optical admittance of previously deposited film. δ is the optical phase thickness of newly deposited thin film, n is the corresponding refractive index.

The solutions of Eq. (6) are:

$$\begin{matrix}δ = arctan [ \pm ( \frac{\sqrt{( α - {α}_{E} ) ( {α}^{2} {α}_{E} - α {α}_{E}^{2} + {α}_{E} {β}^{2} - α {β}_{E}^{2 )} )}}{{α}_{E} β + α {β}_{E}} ] & ( 7 ) \\ n = \pm ( \frac{\sqrt{( α - {α}_{E} ) ( {α}^{2} {α}_{E} - α {α}_{E}^{2} + {α}_{E} {β}^{2} - α {β}_{E}^{2 )} )}}{α - {α}_{E}} & ( 8 )\end{matrix}$$

We should always choose the set of answer whose n and δ are positive. Thus, the complete information about reflection coefficient, optical admittance, refractive index and actual thickness of the growing film stack at every moment can be observed through this optical monitor system.

The monitoring sensitivity of monitoring of reflection coefficient or optical admittance loci, that is change amount per unit of optical phase thickness, should be analyzed in two parts, since the loci move in both two orthogonal directions, directions along the real and imaginary axis as thin film grows. The below equations show the sensitivities of optical admittance locus. Sensitivity X and Sensitivity Y represent sensitivities for real and imaginary parts of optical admittance, respectively.

$$\begin{matrix}Sensitivity X ( {S}_{X} ) = \vert \frac{α ( ( 2 cos δ - 2 \frac{β}{n} sin δ ) ( sin δ + \frac{β}{n} cos δ ) - \frac{{α}^{2}}{{n}^{2}} sin 2 δ )}{{( {( cos δ - \frac{β}{n} sin δ )}^{2} + \frac{{α}^{2}}{{n}^{2}} {sin}^{2} δ )}^{2}} \vert & ( 10 ) \\ Sensitivity Y ( {S}_{Y} ) = \vert \begin{matrix}\frac{\frac{( {n}^{2} - ( {α}^{2} + {β}^{2} ) )}{n} cos 2 δ - 2 β sin 2 δ}{( {( cos δ - \frac{β}{n} sin δ )}^{2} + \frac{{α}^{2}}{{n}^{2}} {sin}^{2} δ )} + \\ \frac{\begin{matrix}( \frac{( {n}^{2} - ( {α}^{2} + {β}^{2} ) )}{2 n} sin 2 δ + β cos 2 δ ) \\ ( ( 2 cos δ - 2 \frac{β}{n} sin δ ) ( sin δ + \frac{β}{n} cos δ ) - \frac{{α}^{2}}{{n}^{2}} sin 2 δ )\end{matrix}}{{( {( cos δ - \frac{β}{n} sin δ )}^{2} + \frac{{α}^{2}}{{n}^{2}} {sin}^{2} δ )}^{2}}\end{matrix} \vert & ( 11 )\end{matrix}$$

where α and β are the real and imaginary part of the equivalent optical admittance of previous film stack, respectively. δ is optical phase thickness, and n is refractive index of thin film.

The sensitivity is low at the termination points of deposition at the left side of the circle of the locus, but in that case, the sensitivity can be greatly improved if we simply adding a phase shift of pi on the reflection phase and re-calculate the corresponding optical admittance, as shown in attachment 1.

| | refractive | | reflection | optical |
|---|---|---|---|---|
| | index | thickness | coefficient | admittance |
| The | 2.119 | 39.039 nm | −0.20708 − 0.34514i | 1.6405 + |
| invention | | | | 1.3513i |
| Ellipsometer | 2.168 | 39.04 nm | −0.23321 − 0.35071i | 1.6939 + |
| | | | | 1.4443i |

Table 1 shows the comparison between the measurement results by monitor system and ellipsometer. Their results are very close to each other.

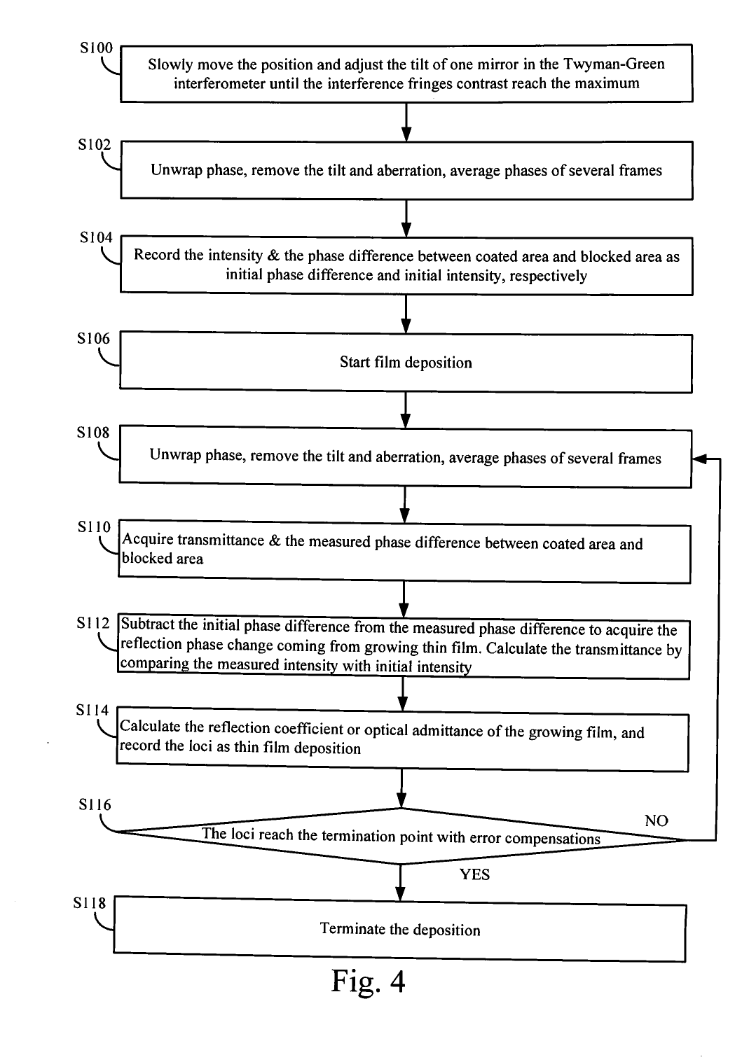

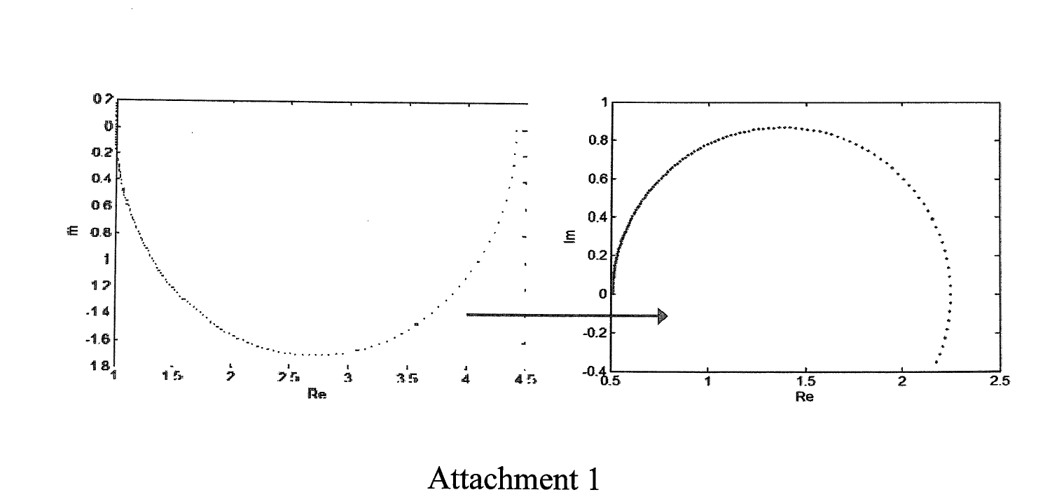

Referring to FIG. 4, the monitoring method of the invention is used to monitor the thin film deposition in real time, and whether the coating thin film is terminated or not is determined by the real time monitoring. As the step S100, a low coherence light of the light source 103 is used to irradiate substrate 14 for suppressing the spurious interference fringes. Adjusting the mirror 109 or 110 of the Twyman-Green interferometer 102 to make the length difference between the two arms be in accordance with the optical thickness of the substrate 14 to make only the specific beam pairs be phase matched and have interference with each other. It makes the calculation reflection phase of thin films easier. The adjusting manner of the interferometer for getting the better perspicuity of the interfering light is common sense, so here is no more explanation. As the step S102, calculating the phase in accordance with the intensity measurement from the pixelated phase mask camera 116, unwrapping the phase of the intensity measurement, removing the tilt factor and aberration of the intensity measurement, and averaging the phase of 15 frames and more captured from the pixelated phase mask camera 116. It is to say, unwrapping the phase difference between the interfering beam pairs, removing the tilt factor and aberration of the phase, and averaging data of the several frames for removing the influence of the air turbulence to the phase. As the step S104, record the intensity & the phase difference between coated area and blocked area as initial phase difference and initial intensity, respectively. As the step 106, Starting the thin film deposition, and then the step 108 is executed. As the step 108, unwrapping the phase of the measurement from the pixelated phase mask camera 116, removing the tilt and aberration of the measurement, averaging phases of 15 frames and more from the pixelated phase mask camera 116.

Then, as the step S110, acquiring transmittance and the measured phase difference between coated area and blocked area of the substrate 14 for obtaining the reflection phase of the thin film. As the step S112, compare the initial phase difference with the measured phase difference to obtain and the reflection phase change, and compare the measured intensity with the initial intensity. It is to say, to subtract the initial phase difference from the measured phase difference for acquiring the reflection phase change of the grown thin film. The transmittance of the thin film is calculated by comparing the measured intensity with initial intensity. Then, as the step S114, calculate the reflection coefficient or optical admittance of the grown thin film, and record the loci as thin film deposition. As the Step S116, determining whether the loci reach the termination point of the thin film deposition or not according to the result of the Step S114. When the determination is yes, the next execution is the step S118. When the determination is no, the next execution is the step S108 to continue monitoring of the thin film deposition. Finally, as the step S118, terminate the thin film deposition.

Moreover, the real-time refractive index and thickness of deposition films can be analytically obtained. It provides a global and precise monitor for fabrications of thin film elements.

The reflection coefficient loci and optical admittance loci as thin film grows can be thereby monitored in this system. From these loci, operators can directly find better error compensations of depositions than transmittance or reflectance loci, since they include both magnitude and phase information of the films. Furthermore, a way to increase the sensitivity of the optical admittance loci monitoring is also proposed in this invention.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

We claimed:

1. A method for monitoring a thin-film, comprising:
providing a substrate having a thin-film;
using a dynamic interferometer to measure the reflection phase of the thin-film through a pixelated phase mask image sensing unit, where the dynamic interferometer has a light source with a low coherence length;
using the polarization interferometer to split the low coherence light to a first linear polarization light and a second linear polarization light in orthogonal polarizations;
irradiating the two linear polarization lights in normal incidence direction to the substrate and the thin film, where the two linear polarization lights occurs the reflection at the two interface on the both sides of the substrate;
the pixelated phase mask image sensing unit receiving all reflected light, and the reflected light beams interfering with each other while the path length differences among the reflected light beams are smaller than the coherence length;
the dynamic interferometer generating the interfering light and acquiring a reflection phase corresponding to the interference intensity;
measuring a film transmittance of the thin film and calculating a non-absorption reflectance of the film, or directly use the pixelated phase mask image sensing unit to measure the reflectance of the film;
obtaining a reflection coefficient corresponding to the different time in accordance with the reflection phase and the reflectance;
calculating the equivalent admittance of the thin film according to the reflection coefficient; and
calculating a thickness and a refractive index of the thin film according to the equivalent admittance.

2. The method as claimed in claim 1, wherein the pixelated phase mask image sensing unit is a photo detector including a birefringence crystal array aligned pixel array combining with a polarizer.

3. The method as claimed in claim 1, wherein the pixelated phase mask image sensing unit is a photo detector including a polarizer array aligned pixel array combining with a quarter-wave plate.

4. The method as claimed in claim 1, wherein the step of the dynamic interferometer generating the interfering light and acquiring a reflection phase corresponding to the interfering light is the pixelated phase mask image sensing unit receives all reflected light and generates different phase shift inteferograms, then the dynamic interferometer obtains the phase according to the phase shifted interferograms.

5. The method as claimed in claim 1, wherein the coherence length of the low coherence light is greater than the total optical thickness of the film and smaller than the optical thickness of the substrate.

6. The method as claimed in claim 1, wherein the step of the dynamic interferometer generating the interference intensity and acquiring a reflection phase corresponding to the interference intensity is provided for acquiring the reflection phase in accordance with the interfering light by using a phase-shifting algorithm.

7. The method as claimed in claim 1, wherein the step of the dynamic interferometer generating the interference intensity and acquiring a reflection phase corresponding to the interference intensity is the dynamic interferometer sensing the interfering light through the pixelated phase mask image sensing unit.

8. The method as claimed in claim 7, wherein an image sensing result of the pixelated phase mask image sensing unit includes a plurality of pixels, the pixels are set by a unit per four pixels. Each unit is recorded a phase.

9. The method as claimed in claim 1, wherein the reflected first linear polarization light and the reflected second linear polarization light passing through the substrate are formed into a plurality reflected light beams; while the path differences between the reflected light beam pairs wherein the two beams in each pair have interference with each other are smaller than the coherence length during the path length difference between the two mirrors to polarization beam splitter is equal to the optical thickness of the substrate.

11. The method as claimed in claim 10, wherein each beam pairs will interfere with each other after passing through the polarizer.

12. The method as claimed in claim 10, wherein a reference reflection surface is inserted on the substrate for the path difference is equal to the distance between the reference surface and back side of the substrate, and the reflection phase, the surface profile with the film deposition change is measured and monitored according to the interference of all beam pairs.

13. The method as claimed in claim 1, wherein the reflection coefficient at each time is recorded to form a loci of the film grow change for obtaining a monitor figure of the film reflection coefficient.

14. The method as claimed in claim 1, wherein the equivalent admittance at each time is recorded to form a loci of the film grow change for obtaining a monitor figure of the film equivalent admittance.

15. The method as claimed in claim 14, wherein the step of adding the monitor sensitivity at the termination points of deposition at the left side of the loci is adding a phase shift of pi on the reflection phase and re-calculate the corresponding optical admittance for monitoring the monitor sensitivity.
